(19) United States
(12) Patent Application Publication
(10) Pub. No.: US 2008/0039178 A1
(43) Pub. Date: Feb. 14, 2008

(54) PROGRESSIVE GAMING DEVICE AND METHOD OF USE

(76) Inventors: Jerald C. Seelig, Absecon, NJ (US); Lawrence M. Henshaw, Hammonton, NJ (US)

Correspondence Address: IAN F. BURNS & ASSOCIATES, P.O. BOX 71115, RENO, NV, 89570, US

(21) Appl. No.: 11/831,713

(22) Filed: Jul. 31, 2007

Related U.S. Application Data
(60) Provisional application No. 60/820,944, filed on Jul. 31, 2006.

(51) Int. Cl. A63F 13/00

(52) U.S. Cl. 463/20

(57) ABSTRACT

A gaming device includes a primary game apparatus having a first random number generator. The primary game apparatus is configured to accept a wager and generate a first random number. A primary game outcome is determined using the first random number. The primary game outcome includes a primary game payout and a bonus qualifying event. A primary game prize is awarded, if the primary game outcome is the primary game payout. A bonus game apparatus is in communication with the primary game apparatus. The bonus game apparatus has a second random number generator. The bonus game apparatus is configured to display several bonus prizes. At least one of the bonus prizes is a progressive jackpot. The bonus game apparatus further generates a second random number and determines the bonus game outcome using the second random number, if the bonus qualifying event has occurred. At least one bonus prize is awarded.

### FIELD OF THE INVENTION

The present invention relates to gaming devices and, more particularly, to a gaming device that provides a bonus game that can award a progressive jackpot using a moveable belt.

### BACKGROUND

Gaming devices are well known in the art and a large variety of gaming devices have been developed. In general, gaming devices allow users or players to play a game. In many casino-type gaming devices, the outcome of the game depends, at least in part, on a randomly generated event. For example, a gaming device may use a random number generator to generate a random or pseudo-random number (hereinafter, both types are referred to as a “random number”).

The random number can be used to determine a game outcome. For example, the random number may then be compared to a predefined table to determine a corresponding outcome of the event. If the random number falls within a certain range of numbers on the table, the player may win the corresponding predefined prize. The table may also contain display information that allows the gaming device to generate a display that corresponds to the outcome of the game. The gaming device may present the outcome of the game on a large variety of display devices, such as mechanical spinning reels or video screens.

Some gaming devices award bonus prizes in addition to prizes that are awarded in a primary game. Of course, the prize in the primary game may simply be the opportunity to play the bonus game. A bonus prize is generally defined as a prize in addition to the prize obtained from the primary game and that is awarded to the player when a predefined event occurs. An example of a bonus game can be found in U.S. Pat. No. 5,848,932 to Adams. Adams discloses a primary game having three spinning game reels and a bonus game having a bonus display with one spinning wheel. The spinning wheel is divided into multiple sections, and each section has a symbol representing a prize. When predetermined indicia are displayed on the spinning game reels of the primary game, the wheel of the bonus display spins and stops. The bonus prize is displayed as the symbol on the wheel being pointed to by a pointer. The bonus prize is awarded in addition to any prizes awarded in the primary game. Another bonus game is disclosed in Baerlocher et al. (U.S. Pat. No. 6,336,863). Baerlocher et al. discloses a slot machine with a bonus award display. The bonus award display has a bonus wheel and a mechanical, movable pointer.

Gaming devices in casinos are more successful when they are able to captivate and hold a game player's interest for a long period of time. When a game player plays a gaming device for a longer period of time, more revenue is generated for the casino. A game player may lose interest with a game that has a static display that changes very little over time or that the player deems to be unattractive.

One way gaming device manufacturers have added additional enjoyment and excitement to gaming devices is through the advent of progressive gaming. Progressive games have become very popular in casinos. Progressive slot machines contain jackpots that increase every time a player places a wager in a primary game of the slot machine. Progressive jackpots involve one or more gaming machines. For example, an individual progressive slot machine has a self-contained jackpot, wherein the jackpot grows with every play of that machine. A linked progressive includes two or more slot machines at the same or different locations connected to a common jackpot, each of which individually contribute to the jackpot. The gaming machines usually take a percentage of the player's wager, such as 2%, and add it to the progressive jackpot. This allows the progressive jackpot to grow over time. The progressive jackpots can reach sizeable amounts, such as multi-million dollar jackpots, before a player “hits” or wins the progressive jackpot.

Large progressive jackpots can be very attractive to casino game players. Furthermore, as the progressive jackpot grows, so does the game's payout percentage because the game pays out more while the likelihood of receiving the progressive award or jackpot remains constant.

Players looking to inject skill or strategy into a gaming event therefore look to find progressive games having relatively high progressive jackpots, i.e., games that have not recently paid out. In an effort to further increase the excitement and enjoyment of progressive games and gaming devices in general, it is therefore desirable to inject player interaction, skill, strategy or risk into a progressive gaming device.

Unfortunately, progressive jackpots pay awards very infrequently. The long periods of time between progressive awards causes gaming machine players to eventually lost interest in the game and stop playing. This is especially true in casino locations where a large number of linked progressives are located. It can appear to game player in these locations that there are no winning game players and that the progressive prize will almost never be awarded. What is needed is a gaming device that can award bonus prizes and progressive jackpots in an entertaining and highly visible manner in order to retain and prolong player interest.

### SUMMARY OF ONE EMBODIMENT OF THE INVENTION

### Advantages of One or More Embodiments of the Present Invention

The various embodiments of the present invention may, but do not necessarily, achieve one or more of the following advantages:

the ability to provide game players with a more exciting and desirable gaming experience;

the ability to attract more patrons to play a game;

provide longer play times and a greater payout possibility for a player;

provide greater revenues for gaming operators;

provide a gaming device that can award several progressive jackpots;

provide a gaming device that utilizes a visually appealing and highly visible display;

provide a gaming device that uses a moveable belt and a display to display to game players a progressive jackpot;

provide a gaming device that uses a moveable belt with a transparent window;

provide a gaming device that can determine a bonus game outcome using a random number generated by a bonus game controller;

provide a gaming device that can determine a progressive game outcome using a bonus game controller; and

provide a gaming device that can display several progressive jackpots;

These and other advantages may be realized by reference to the remaining portions of the specification, claims, and abstract.

### Brief Description of One Embodiment of the Present Invention

In certain embodiments, the present invention relates to a gaming device that includes a primary game apparatus that has a first random number generator. The primary game apparatus is configured to accept a wager and generate a first random number. A primary game outcome is determined using the first random number. The primary game outcome includes a primary game payout and a bonus qualifying event. A primary game prize is awarded, if the primary game outcome is the primary game payout. A bonus game apparatus is in communication with the primary game apparatus. The bonus game apparatus has a second random number generator. The bonus game apparatus is configured to display several bonus prizes. At least one of the bonus prizes is a progressive jackpot. The bonus game apparatus further generates a second random number and determines the bonus game outcome using the second random number, if the bonus qualifying event has occurred. At least one bonus prize is awarded.

In other embodiments, the present invention relates to a gaming method. According to the method, a wager is accepted and a primary game outcome is determined using a primary game controller. The primary game outcome includes a primary game payout and a bonus qualifying event. A primary game prize is awarded, if the primary game outcome is the primary game payout. A bonus game apparatus is activated, if the bonus qualifying event occurs. Several bonus prizes are displayed with at least one of the bonus prizes being a progressive jackpot. A bonus game outcome is determined using a bonus game controller, if the bonus qualifying event has occurred. A bonus prize is indicated and awarded.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a front view of a gaming device of the present invention.

FIG. 2 is substantially a front view of FIG. 1 with the moveable belt removed to show all of the progressive jackpot displays.

FIG. 3 is substantially a diagrammatic view of a portion of the gaming device of FIG. 1.

FIG. 4 is substantially a schematic diagram of a portion of the gaming device of FIG. 1.

FIG. 5 is substantially a schematic diagram of several of the gaming devices of FIG. 1 connected in a network.

FIG. 6 is substantially a flowchart of a gaming method of the present invention.

### DESCRIPTION OF CERTAIN EMBODIMENTS OF THE PRESENT INVENTION

In the following detailed description of the embodiments, reference is made to the accompanying drawings, which form a part of this application. The drawings show, by way of illustration, specific embodiments in which the invention may be practiced. It is to be understood that other embodiments may be utilized and structural changes may be made with out departing from the scope of the present invention.

Gaming Apparatus

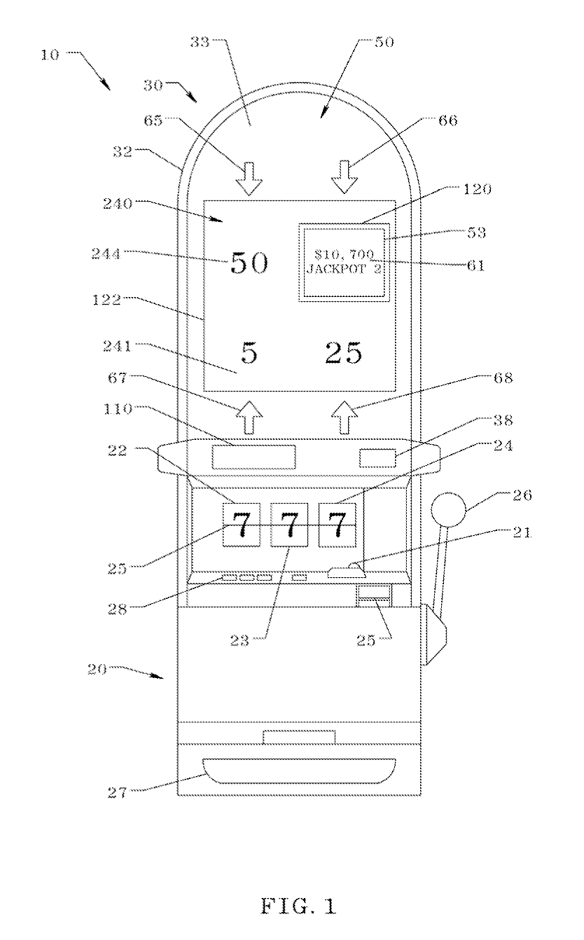

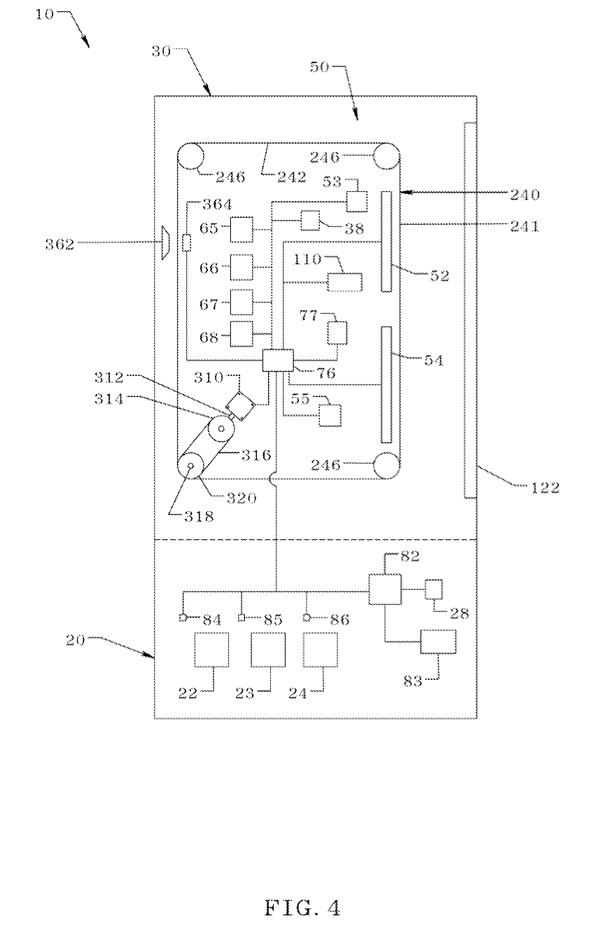

Referring to FIG. 1, one embodiment disclosed herein comprises a gaming apparatus or device, generally indicated by reference number 10. Gaming device 10 comprises a primary game apparatus 20 and a bonus game apparatus 30. Bonus game apparatus 30 may comprise a display device 50. Game apparatus 20 may be any of a large number of devices that are adapted to allow players to play a game. For example, game apparatus 20 may utilize reel displays, such as spinning reels 22-24 or a video display (not shown), to display outcomes of the game. Sensors 84, 85 and 86 (FIG. 4) may be provided to detect the position of spinning reels 22-24, respectively. Means may also be provided for accepting wagers, such as a coin slot 21 or card reader 25, and for awarding prizes, such as a coin dispenser 27. A handle 26 and button 28 are provided for activating game apparatus 20 to begin a game. In at least one embodiment, game apparatus 20 may be an S Plus model gaming device manufactured by International Game Technology in Reno, Nev.

Game apparatus 20 may be controlled by a primary game controller 82 (FIG. 4) that is in communication with and utilizes a random number generator 83 (FIG. 4). The random number generator produces a random or pseudo random number for each game. The outcome of the game may be determined by comparing the random number to a table of outcomes stored in a memory and accessed by controller 82. A number of different tables of outcomes may be used and different tables may be used for different games. The tables can be designed so that different prizes have different probabilities of being awarded. Such design techniques are well known in gaming. Examples of such designs are shown in U.S. Pat. No. 4,448,419, issued to Telnaes, and U.S. Pat. No. 5,456,465, issued to Durham. Controller 82 causes spinning reels 22-24 of the video display to show the outcome of the game that corresponds to the outcome of the random number generator. It is recognized that game apparatus 20 may operate in many other ways and still achieve the objects of the present invention.

Game apparatus 20 may also be capable of producing a bonus qualifying event. This event may be many different types of events. For example, a bonus qualifying event may comprises displaying a particular symbol, such as a “bonus” symbol, or combination of symbols, such as three “7” symbols, on reels 22-24 as shown in FIG. 1. If the game being played is poker based, the bonus qualifying event may be occurrence of a certain hand, such as a royal flush. Furthermore, a bonus qualifying event may occur when a player accumulates a number of symbols or game outcomes over a number of separate game plays. For example, a bonus qualifying event may occur when the players receives three “bonus” symbols during a period of time. The bonus qualifying event may be based on an external event. For example, a bonus qualifying event may occur when a group of players obtained a certain result.

Bonus Game

Referring to FIGS. 1-4, bonus game apparatus 30 may have a housing 32 with a front panel 33. Housing 32 can be made from any different materials such as metal or plastic and can include decorative coverings or attachments and lights. Housing 32 can have a transparent portion or window 122. A player input device 38 can be mounted in housing 32. Player input device 38 can be buttons or handles or rotary knobs. Player input device 38 can allow a game player to provide input to bonus game apparatus 30. A display 110 such as a credit meter can be used to display prizes won on bonus game apparatus 30.

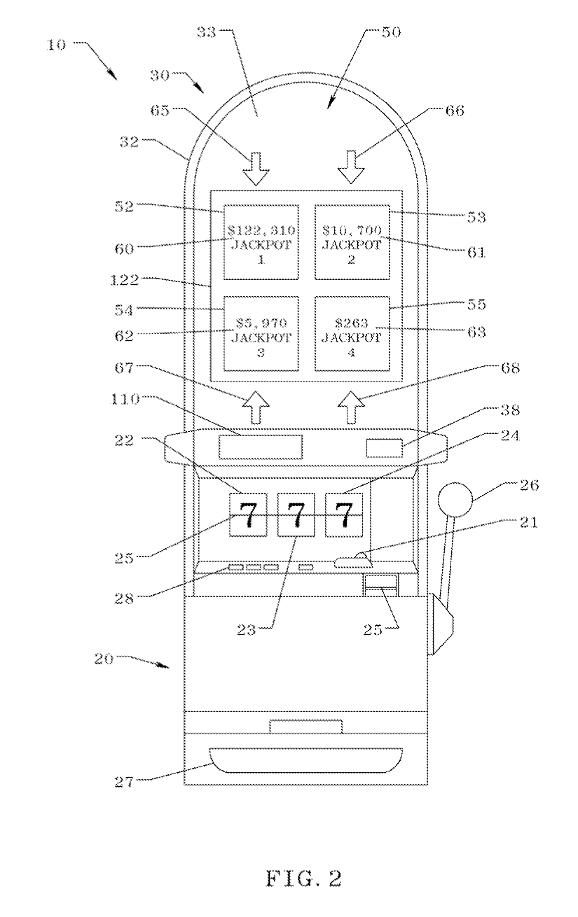

A display device 50 such as a moveable band or belt 240 and video displays 52, 53, 54 and 55 (FIG. 2) can be mounted in front panel 33. Moveable belt 240 can have various indicia 244 mounted thereon. Video displays 52-55 can be any suitable display including video displays, plasma displays, LCD displays, LED meters and the like.

Display device 50 may be activated upon the occurrence of a bonus qualifying event in primary game apparatus 20. As seen in FIG. 1, display device 50 is shown with moveable belt 240 having an outer surface 241 in a stopped position. Bonus prize indicia 244 are located on outer surface 241. Indicia 244 may be affixed, imprinted, engraved, or otherwise represented on outer surface 241. Indicia 244 may represent various things, including prize amounts, multipliers, a description or representation of merchandise or services, progressive prizes, or jackpot prizes.

Moveable belt 240 may move in various directions. As shown in FIG. 1, indicia 244 move up and down or vertically. Of course, indicia 244 could be configured to move horizontally.

Several indicators 65, 66, 67 and 68 are mounted on front panel 33. Indicators 65-67 can be any suitable indicator such as an arrow or pointer. Indicators 65-67 may be illuminated if desired. Indicators 65-67 may point to one or more indicia 244 on moveable belt 240 or may point to one or more of video displays 52-55. Indicators 65-68, indicia 244 and video displays 65-67 in combination may indicate a bonus game outcome to a game player.

Moveable belt 240 can have a transparent window 120 through which video display 53 is visible. Video display 53 may display a progressive jackpot 61. Progressive jackpot 61 has an associated award value that can be awarded to a player as a prize. A wide variety of awards, such as trips, vouchers, gaming credits, comps for meals or hotels or monetary awards can be awarded. As shown in FIG. 1, progressive jackpot 61 is identified as jackpot number 2 and shown having a current value of $10,700. A game player playing gaming device 10 may be awarded one, two, three or all four of progressive jackpots 52-55.

Video display 52 can display a progressive jackpot 60. Video display 54 can display a progressive jackpot 62 and video display 55 can display a progressive jackpot 63.

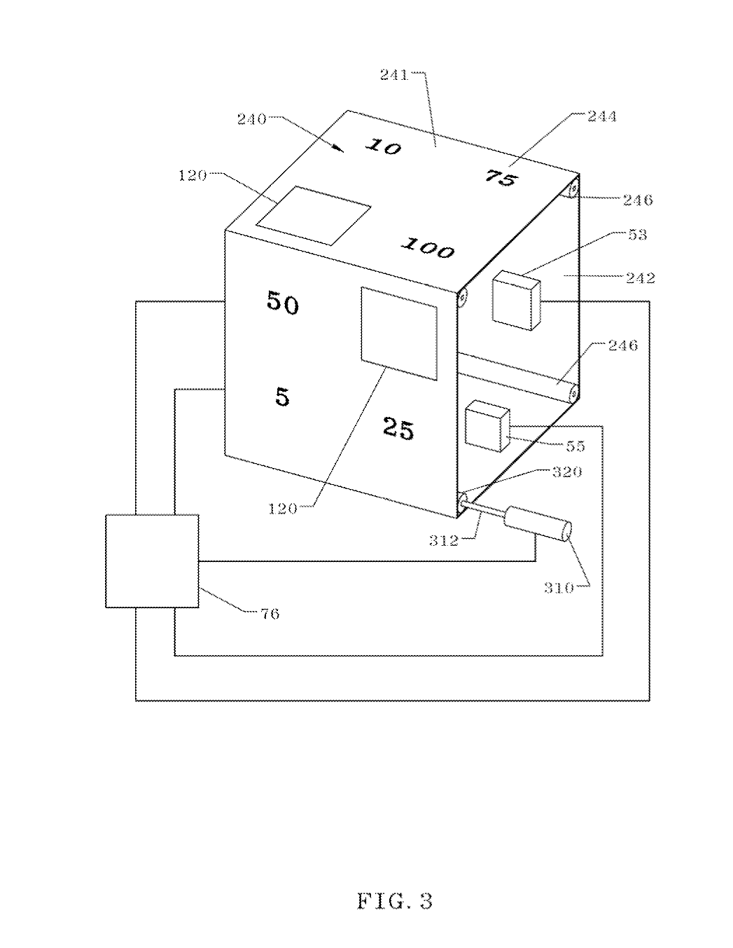

With continued reference to FIGS. 1 and 2 and specific reference to FIGS. 3 and 4, bonus game apparatus 30 comprises a bonus game controller 76 that is adapted to control the operation of the game apparatus. Controller 76 may be one or more micro-computers or processor boards. A random number generator 77 may be in communication with controller 76. Random number generator 77 is capable of randomly generating a random number and providing the random number to controller 76. Bonus game controller 76 may be in communication with primary game controller 82.

It is recognized that controller 76 and random number generator 77 may be a single processor or processor board. Furthermore, it is also recognized that controller 76 and 82, and random number generators 77 and 83 may be combined in a single processor or processor board.

Moveable belt or band 240 may resemble a printing press, including a magazine printing press, a newspaper printing press, and a money printing press. Moveable belt 240 can have an outer surface 241 and an inner surface 242. At least a portion of rollers 246 are arranged such that belt 240 is displayed at a first position located towards the front of housing 32. Belt 240 then may be directed to a second position, such as passing behind driven roller 320, where belt 240 is located more in an interior portion of housing 32. In this way, belt 240 may appear to be rotating and moving.

Moveable belt 240 may be constructed from any suitable material. Belt 240 may be constructed from a flexible material, such as various types of vinyl, plastic, rubber materials, and the like. The use of a flexible material may prevent band 240 from tearing or creasing when it is moved. The material used to construct band 240 may be transparent or translucent, allowing band 240 to be backlit. A portion of moveable belt 240 may contain a transparent window 120.

Band 240 may be coupled to a drive mechanism so that moveable belt 240 may be rotated about rollers 246. In operation, belt 240 may be actuated prior to a bonus prize being awarded to the player.

In at least one embodiment, indicators 65, 66, 67 and 68 are included that may point to particular indicia 244. Indicators 65-68 may be configured to point to an indicia 244 that conveys the outcome of a bonus game. Indicators 65-68 can each include a light that is in communication with controller 76, thereby allowing controller 76 to turn the indicator on and off to indicate one of indicia 244 or one of displays 52-55. The light may be of any suitable type, including light emitting diodes (LEDs).

Controller 76 may direct indicators 65-68 to illuminate and deactivate in accordance with game events, such as the execution of an attract mode, or a game outcome qualifying a player to play a bonus game.

Moveable band 240 may be wrapped around a plurality of idle rollers 246. In at least one embodiment, all rollers 246 are idler rollers that simply guide band 240. One suitable roller is model number E8S001-01-ZZZZ available from Starpoint Electronics, Ltd. of Chessington, UK. A driven roller 320 may be included to drive band 240. Driven roller 320 may be in communication with an actuator 310 in order to drive rotation of driven roller 320. One suitable driven roller is model E8S002-01-ZZZZ from Starpoint.

In at least one embodiment, band 240 is driven simply by frictional contact with roller 320. However, other arrangements may be substituted without departing from the scope of the present invention. For example, roller 320 may have a portion with teeth (not shown) that could engage slots or holes (not shown) in band 240.

Actuator 310 may be any number of suitable actuators, such as motors, including stepper motors, gear motors, and servo motors. Actuator 310 may rotate a shaft 312 in connection with a wheel 314. A belt 316 may link wheel 314 to shaft 318 of driven roller 320. Rotation of shaft 312 drives wheel 314 which in turn drives belt 316. The rotational force is passed from belt 316 to shaft 318. Rotation of shaft 318 may drive rotation of roller 320. Frictional contact with rotating driven roller 320 moves band 240. Optionally, an idler wheel or pulley (not shown) can be included on the opposing side of band 240 in order to increase the frictional contact of band 240 with driven roller 320.

In another embodiment, actuator 310 may be a stepper motor rotating a drive gear (not shown). The drive gear may be in communication with a spur gear (not shown) driving an idler shaft (not shown). The idler shaft in turn may be in communication with driven roller 320. The idler shaft may also used to help transfer power to the side of band 240 not located by actuator 310.

Controller 76 may also be in communication with a positioning system for moveable belt 240. It may be beneficial to be able to track the position of moveable belt 240. For example, when a game outcome is determined, it is important to make sure that moveable belt 240 is in the correct position to display the appropriate indicia 244 on band 240.

Many suitable positioning systems can be used, for example, an infrared signal source 362 can be included on one side of band 240. An infrared detector 364 may be located on the opposing side of band 240. Infrared blocking materials may be placed at one or more locations on band 240. By tracking when the infrared signal is blocked, controller 76 may be able to calibrate and/or constantly track the position of band 240 and any indicia appearing thereon.

In an alternative embodiment, a side of band 240 contains a series of holes (not shown), cut-out portions, or similar optical interrupts. The optical interrupts may be read by an optical reader (not shown). The optical interrupts may convey the position of band 240 to controller 76.

Indicia 244 may represent prizes that a player may be awarded. For example, indicia 244 may represent an amount of money or gaming credits. Indicia 244 may represent a multiplier by which the player's winnings from one or more gaming rounds may be multiplied. Indicia 244 may represent special awards, such as a good, a service, a jackpot, or a progressive amount. Of course, indicia 244 may represent many other prizes without departing from the scope of the present invention.

Moveable belt 240 can have several transparent windows 120 through which video displays 52, 53, 54 and 55 are visible. Each of video displays 52-55 may display a progressive jackpot. Video displays 52-55 can be mounted in housing 32 behind moveable belt 240 adjacent to inner surface 242. Video displays 52-55 are in electrical communication with controller 76. Moveable belt 240 can be moved by actuator 310 such that window 120 is positioned and aligned with one of displays 52-55. For example, controller 76 may position moveable belt 240 such that video display 54 showing progressive jackpot 62 is shown to a game player. Alternatively, windows 120 may be arranged in moveable belt 240 such that more than one video display and progressive jackpot are shown at any one time.

Progressive jackpot 61 has an associated award value that can be awarded to a player as a prize. A wide variety of awards, such as trips, vouchers, gaming credits, comps for meals or hotels or monetary awards can be awarded. As shown in FIG. 1, progressive jackpot 61 is identified as jackpot number 2 and shown having a current value of $10,700. A game player playing gaming device 10 may be awarded one, two, three or all four of progressive jackpots 52-55.

Controller 76 is adapted to detect when a bonus qualifying event occurs in game apparatus 20. This may be accomplished by game apparatus controller 82 transmitting a signal to controller 76 that a bonus qualifying event has occurred. For example, controller 82 may determine the outcome of each game and when a bonus qualifying event outcome occurs, it transmits a signal to controller 76. Alternatively, controller 76 may periodically interrogate controller 82. In another embodiment, one or more sensors may be provided for determining if a bonus qualifying event has occurred. For example, sensors 84-86 may sense the positions of reels 22-24. When reels 22-24 are in a bonus qualifying event activating position, controller 76 would sense this position and begin a bonus game sequence (described below). Sensors may also be provided external to gaming device 10 to detect external bonus qualifying events.

Controller 82 may also transmit a variety of information to controller 76. For example, controller 82 may signal when coins or currency have been inserted, when a game starts, when an error has occurred, and when a sensor detects tampering.

When controller 76 detects a bonus qualifying event, it may begin a bonus sequence by activating display device 50. The may include activation of displays 52-55, moving moveable belt 240, indicators 65-68 and display 110. Display 110 may comprise many different kinds of display devices, such as video screens, lights, light emitting diodes, etc. Display 110 may comprise its own controller that is adapted to generate a variety of displays.

Display 110 may indicate that a player has qualified for a bonus game and prompt the player to perform an action. In an embodiment, the player is prompted to start the bonus game sequence by pressing input device 38. Input device 38 may be a simple button, a keyboard, or a touch screen display.

When controller 76 detects input device 38 being activated, controller 76 performs a routine to determine the bonus game outcome and which bonus prize will be awarded. In an embodiment, the bonus prize to be awarded is randomly selected. Random number generator 77 generates a random number and supplies the random number to controller 76. Controller 76 compares the random number to a pay table similar to that described for game apparatus 20 or as described in U.S. Pat. No. 5,823,874, issued to Adams. A simple pay table may appear as follows:

TABLE 1

| Random Number | Award |
|---|---|
| 0.00 to 0.45 | 5 |
| 0.46 to 0.56 | 10 |
| 0.57 to 0.66 | 25 |
| 0.67 to 0.75 | 50 |
| 0.76 to 0.83 | 75 |
| 0.84 to 0.89 | 100 |
| 0.90 to 0.94 | Jackpot 4 |
| 0.93 to 0.96 | Jackpot 3 |
| 0.97 to 0.98 | Jackpot 2 |
| 0.99 to 1.00 | Jackpot 1 |

For example, if the random number generator produced 0.64, controller 76 would cause actuator 310 to move movable belt 240 to a position to indicate a bonus prize of 25 credits as being won and the credits would be awarded to the player. If the random number generator produced 0.97, moveable belt 240 would be moved to a position where display 53 is visible to the game player and progressive jackpot 2 would be indicated as being won and the award amount contained by progressive jackpot 2 would be awarded to the player.

This embodiment is not necessarily limited to the example pay table shown. A larger or less number of bonus prizes and progressive jackpots may be used. Furthermore, different kinds of prizes may be awarded along with a bonus prize or progressive jackpot. For example, a progressive jackpot and a vacation could be awarded or a progressive jackpot and an award to play additional games could be awarded.

Once controller 76 randomly determines which bonus prize is to awarded, controller 76 causes display device 50 to indicate the bonus prize or prizes that have been won. Controller 76 may be programmed with the coordinates of each indicia 244 and window 120, allowing controller 76 to ensure that the proper indicia 244 or window 120 corresponding to a game outcome is displayed once band 240 is stopped.

Controller 76 first moves and then stops moveable belt 240 such that at least one of indicia 244 or windows 120 is adjacent one of indicators 65-68. Controller 76 also causes video displays 52-55 to display progressive jackpots 60-63. A game player viewing display device 50 will be able to view progressive jackpots 60-63 through windows 120 for a period of time until moveable belt 240 moves to cover the video displays 52-55.

After moveable belt 240 is stopped, one of the indicators 65-68 is illuminated to indicate the bonus game outcome and the bonus prize to be awarded. For example, as shown in FIG. 1, display device 50 is shown indicating that the game player has won progressive jackpot 2. Controller 76 has positioned moveable belt 244 such that window 120 is aligned with video display 53. Video display 53 is shown displaying progressive jackpot 61. Indicator 66 such as an arrow may be illuminated or flashed above progressive jackpot 61 in order for a game player to clearly see what they have won. If more than one progressive jackpot is to be awarded, the indicator can be illuminated or flashed adjacent to each progressive jackpot that is to be awarded.

Controller 76 may then cause display 110 to display the total prize, if any, that the player has won. Other effects may also be presented, such as pre-recorded sound from speakers. If the actual prize is money, the amount of the prize may be added to the player's credit meter or dispensed.

After controller 76 awards a progressive jackpot, controller 76 updates the video display with at least one new progressive award value. For example, if progressive jackpot 61 was awarded, the award value shown video display 53 would be set to zero and would then start accumulating value as it is funded.

Controller 76 can further determine the funding of progressive jackpots 60-63. A portion of the wagers placed on gaming device 10 is reserved to increase the amounts of the progressive jackpots 60-63. The distribution percentages of the total available contribution amount to each progressive jackpot may be randomly determined by the controller or may be fixed. Controller 76 can determine a percentage of each wager placed on primary gaming device 10 to fund several progressive jackpots. For example, two percent of each wager placed on the primary gaming device may be allocated to fund the progressive jackpots.

It is also possible to replace the primary display of a gaming device with display device 50. Game apparatus 20 may be entirely replaced by display device 50. In other words bonus gaming apparatus 30 can be used as a primary or base game apparatus.

Network of Gaming Devices

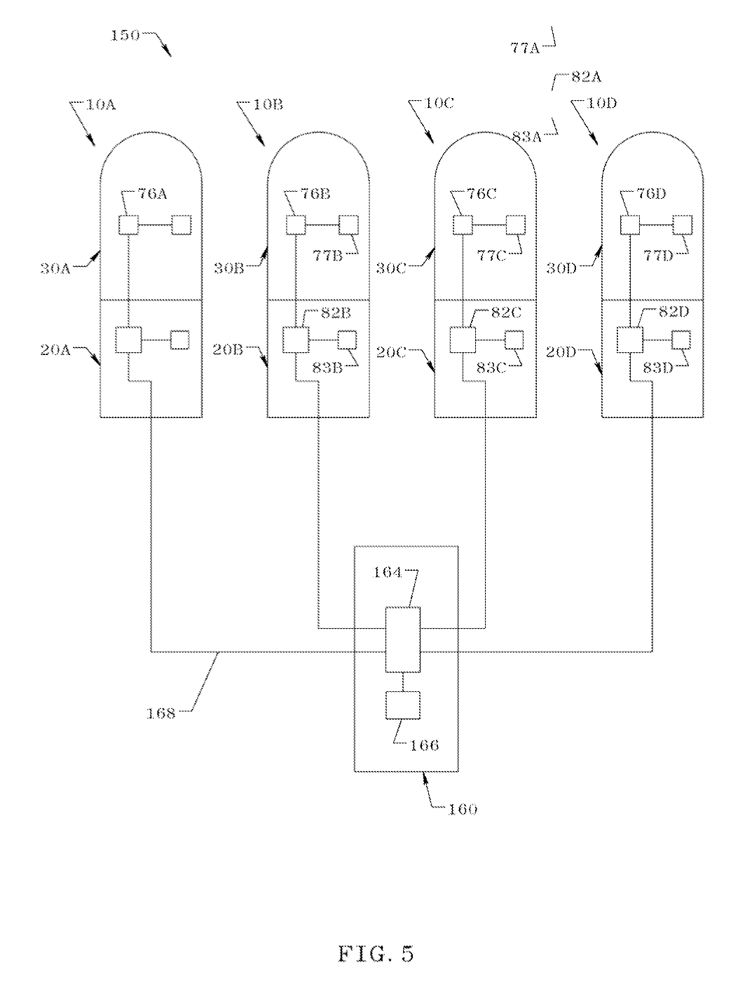

With reference to FIG. 5, a network 150 of gaming devices 10 is shown. Network 150 can include several interconnected gaming devices 10A, 10B, 10C and 10D. While four gaming devices are shown more less can be used. Gaming devices 10A-D can each have a primary game apparatus 20A-D and a bonus game apparatus 30A-D, respectively. Each of primary gaming apparatuses 20A-D can have a controller 82A-D and random number generator 83A-D, respectively.

Gaming devices 10A-D may be in communication with a computer network server 160 through cables 168 such as an Ethernet cable. Server 160 can be a conventional network server that contains a memory 166, a controller or processor 164 and software that can operate on the processor.

Server 160 can collect and transmit game information and instructions between server 160 and gaming devices 10A-10D. For example, server 160 can apportion a percentage of each wager placed on gaming devices 10A-10D to fund progressive jackpots 60-63.

Game Play Flow Chart

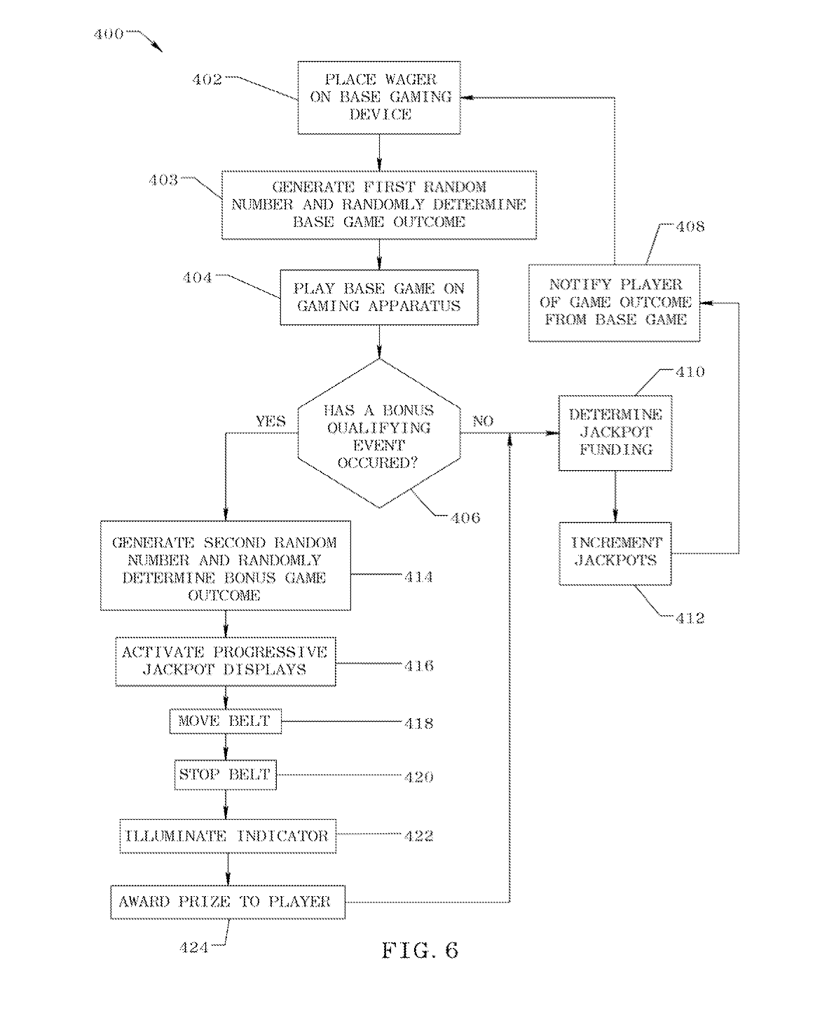

Referring now to FIG. 6, a flowchart of a method of game play 400 using gaming device 10 is shown. At step 402, a player may initiate game play method 400 by placing a wager on gaming device 10. The wager may be in form of cash or credit from actual domestic or foreign currency, vouchers, coupons, tickets, electronic cards, and other sources or forms of wagers known in the art. Once the player initiates game play 400, the primary game random number generator generates a first random number and randomly determines the primary game outcome at step 403. Next, the player may play a base or primary game on the gaming apparatus at step 404.

At step 406, the controller detects the occurrence of a bonus qualifying event. If the controller does not detect a bonus qualifying event, method 400 proceeds to step 410 where the progressive jackpot funding is determined. After the progressive jackpot funding is determined in step 410, the progressive jackpots are incremented in step 412. Next, the controller notifies the player of the game outcome from the base game at step 408 and returns to step 402 to continue playing a game on the primary gaming apparatus.

If the controller detects a jackpot qualifying event at step 406, the bonus game random number generator generates a second random number and randomly determines the bonus game outcome or award at step 414. The controller may award one or more bonus prizes or one or more progressive jackpots or a combination of a bonus prize and a progressive jackpot as an award to the game player. Next, the controller activates and displays the progressive jackpots on the video displays at step 416. At step 418, the moveable belt or band is moved. The moveable belt is stopped at step 420. One or more indicators are illuminated at step 422 and any bonus or progressive jackpot prizes are awarded at step 424.

The steps shown in the flowchart do not necessarily imply that the steps have to take place in a particular order. The order of steps may be varied; some steps may be eliminated; and, some steps may be replaced with other steps. Such variations still fall within the scope of the invention.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A gaming device comprising:
(A) a primary game apparatus having a first random number generator, the primary game apparatus configured to:
(a) accept a wager;
(b) generate a first random number;
(c) determine a primary game outcome using the first random number, the primary game outcome including a primary game payout and a bonus qualifying event;
(d) award a primary game prize, if the primary game outcome is the primary game payout;
(B) a bonus game apparatus in communication with the primary game apparatus, the bonus game apparatus having a second random number generator, the bonus game apparatus configured to:
(a) display a plurality of bonus prizes, at least one of the bonus prizes being a progressive jackpot;
(b) generate a second random number
(c) determine a bonus game outcome using the second random number, if the bonus qualifying event has occurred; and
(d) award at least one bonus prize.

2. The gaming device of claim 1, wherein the bonus game apparatus further comprises a moveable belt for displaying the bonus prizes.

3. The gaming device of claim 2, wherein the moveable belt has at least one transparent window.

4. The gaming device of claim 2, wherein the bonus game apparatus further comprises at least one display mounted adjacent to the moveable belt, the display being adapted to show the progressive jackpot.

5. The gaming device of claim 4, wherein the display is visible through a window in the moveable belt.

6. The gaming device of claim 1, wherein the bonus prizes further include a plurality of progressive jackpots.

7. The gaming device of claim 2, wherein an indicator is mounted adjacent to the moveable belt to indicate the bonus prize to be awarded.

8. A method of gaming, comprising, not all necessarily in the order shown:
(A) accepting a wager;
(B) determining a primary game outcome using a primary game controller, the primary game outcome including a primary game payout and a bonus qualifying event;
(C) awarding a primary game prize, if the primary game outcome is the primary game payout;
(D) activating a bonus game apparatus, if the bonus qualifying event occurs;
(E) displaying a plurality of bonus prizes, at least one of the bonus prizes being a progressive jackpot;
(F) determining a bonus game outcome using a bonus game controller, if the bonus qualifying event has occurred;
(G) indicating a bonus prize; and
(H) awarding the bonus prize.

9. The method of claim 8, further comprising generating a first random number using the primary game controller and a second random number using the bonus game controller.

10. The method of claim 8, wherein the bonus prizes include a plurality of progressive jackpots.

11. The method of claim 8, further comprising:
(A) moving a moveable belt; and
(B) stopping the moveable belt.

12. The method of claim 8, further comprising displaying the progressive jackpot on a display.

13. The method of claim 8, further comprising incrementing the progressive jackpot.

14. A gaming device comprising:
(A) primary game means for allowing a player to play a primary game;
(B) primary game controller means for determining a primary game outcome, the primary game outcome including a primary game payout and a bonus qualifying event;
(C) bonus game means for allowing a player to play a bonus game, the bonus game means including a plurality of bonus prizes and at least one progressive jackpot;
(D) bonus game controller means for selecting at least one of the bonus prizes to be awarded, if the bonus qualifying event occurs;
(E) display means for displaying the selected bonus prize; and
(F) award means for awarding the selected bonus prize.

15. The gaming device of claim 15, wherein the primary game controller generates a first random number to determine the primary game outcome.

16. The gaming device of claim 15, wherein the bonus game controller means generates a second random number to determine the bonus game outcome.

17. The gaming device of claim 15, wherein the display means further comprises:
(A) a moveable belt having a window;
(B) a display visible through the window, the display showing the progressive jackpot.

18. The gaming device of claim 17, wherein the display means further comprises:
(A) an actuator in communication with the bonus game controller means, the actuator configured to move and stop the moveable belt.
